(19) United States
(12) Patent Application Publication
(10) Pub. No.: US 2026/0024973 A1
(43) Pub. Date: Jan. 22, 2026

(54) ELECTRICAL JUNCTION BOX

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Taiji YANAGIDA, Osaka (JP); Hiroki SHIMODA, Osaka (JP); Koushi IGURA, Osaka (JP); Yusuke OKUHIRA, Mie (JP); Maiko ISSHIKI, Mie (JP); Kouki AIDA, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 19/108,252

(22) PCT Filed: Sep. 13, 2023
(86) PCT No.: PCT/JP2023/033279

§ 371 Date: Mar. 3, 2025

(30) Foreign Application Priority Data
Sep. 14, 2022 (JP) 2022-146344

(51) Int. Cl. H02G 3/16; H02G 3/03; H02G 3/08

(52) U.S. Cl. CPC H02G 3/16; H02G 3/03; H02G 3/081

(57) ABSTRACT

An electrical junction box includes a housing in which a plurality of bus bars are housed, and heat from the bus bars is dissipated externally via the housing. The electrical junction box includes a first heat dissipation portion that is spaced apart from the bus bars by a first distance or less and dissipates heat by emission, and a second heat dissipation portion that is spaced apart from the bus bars by a second distance or more and dissipates heat by convection.

### TECHNICAL FIELD

The present disclosure relates to an electrical junction box.

This application claims priority to Japanese Application No. 2022-146344, filed on Sep. 14, 2022, the entire disclosure of which is hereby incorporated herein by reference.

### BACKGROUND ART

Conventionally, many vehicles include an electrical connection device that is provided between a power source and an electrical device and supplies electric power from the power source to the electrical device.

Patent Document 1 discloses an electrical connection device that includes a housing for housing an electromagnetic relay, and the housing has an opening provided in the vicinity of the electromagnetic relay to dissipate heat from the inside of the housing to the outside.

### CITATION LIST

### Patent Documents

Patent Document 1: JP 2021-83160A

### SUMMARY OF INVENTION

An electrical junction box according to an embodiment of the present disclosure includes a housing in which a plurality of bus bars are housed, heat from the bus bars being dissipated externally via the housing, the electrical junction box including: a first heat dissipation portion spaced apart from the bus bars by a first distance or less and configured to dissipate heat by emission; and a second heat dissipation portion spaced apart from the bus bars by a second distance or more and configured to dissipate heat by convection.

### BRIEF DESCRIPTION OF DRAWINGS

FIG. 1 is a perspective view of an electrical junction box according to an embodiment.

FIG. 2 is a plan view of the electrical junction box according to the embodiment.

FIG. 3 is a bottom view of the electrical junction box according to the embodiment.

FIG. 4 is a plan view showing the electrical junction box according to the embodiment with the upper case removed.

FIG. 5 is a perspective view showing the electrical junction box according to the embodiment with the upper case removed.

FIG. 6 is a vertical cross-sectional view taken along a line VI-VI in FIG. 2.

FIG. 7 is a vertical cross-sectional view taken along a line VII-VII in FIG. 2.

### DESCRIPTION OF EMBODIMENTS

### Problems to be Solved by Present Disclosure

For example, in the case of an electronic component such as a relay that generates heat during energization, in reality, it is not possible to expect a significant heat dissipation effect by the dissipation of heat from the electronic component itself, and it is more efficient to perform heat dissipation via a bus bar that is connected to such an electronic component and is exposed to the air.

However, in the electrical connection device of Patent Document 1, the opening is provided in the housing at a position in the vicinity of the electromagnetic relay, and heat is only dissipated from the electromagnetic relay itself, with no consideration given to heat dissipation via a bus bar, thus making it difficult to say that heat is efficiently dissipated from the electromagnetic relay.

In view of this, an object of the present invention is to provide an electrical junction box that can more effectively dissipate heat generated by an electronic component when energized.

### Advantageous Effects of Present Disclosure

According to the present disclosure, it is possible to provide an electrical junction box in which heat from an electronic component that generates heat when energized can be dissipated more effectively.

### Description of Embodiments of Present Disclosure

First, embodiments of the present disclosure will be listed and described. Also, at least some of the embodiments described below may be combined as desired.

(1) An electrical junction box according to an embodiment of the present disclosure includes a housing in which a plurality of bus bars are housed, heat from the bus bars being dissipated externally via the housing, the electrical junction box including: a first heat dissipation portion spaced apart from the bus bars by a first distance or less and configured to dissipate heat by emission; and a second heat dissipation portion spaced apart from the bus bars by a second distance or more and configured to dissipate heat by convection.

In this embodiment, the first heat dissipation portion dissipates heat by emission and the second heat dissipation portion dissipates heat by convection, and by appropriately combining the first heat dissipation portion and the second heat dissipation portion to dissipate heat, heat from an electronic component can be dissipated more effectively via the bus bars.

(2) In the electrical junction box according to an embodiment of the present disclosure, an emissivity of the housing is higher than an emissivity of the bus bars.

In this embodiment, the emissivity of the housing is greater than the emissivity of the bus bars, and therefore by using the first heat dissipation portion and the second heat dissipation portion to dissipate heat from the bus bars to the outside via the housing, heat from an electronic component can be dissipated efficiently.

(3) In the electrical junction box according to an embodiment of the present disclosure, the first heat dissipation portion has one surface opposing the bus bars.

In this embodiment, one surface of the first heat dissipation portion opposes the bus bar, and the other surface is exposed to the outside air, thus making it possible to improve the effect of dissipating heat by emission.

(4) In the electrical junction box according to an embodiment of the present disclosure, the second heat dissipation portion has a through hole.

In this embodiment, the second heat dissipation portion has a through hole, and therefore air can flow into and out of the housing through the through hole, and the effect of heat dissipation by convection can be improved.

(5) In the electrical junction box according to an embodiment of the present disclosure, a fixing member fixing a bus bar among the plurality of bus bars to another component protrudes at a position corresponding to the through hole.

In this embodiment, the fixing member for fixing the bus bar to another component protrudes at a position opposing the through hole of the second heat dissipation portion, and therefore a gap is formed between the wall of the housing and the second heat dissipation portion, thus allowing air to flow easily and enabling the second heat dissipation portion to efficiently dissipate heat.

(6) In the electrical junction box according to an embodiment of the present disclosure, the electrical junction box further includes: a fixing wall configured to be fixed to a target object, wherein the plurality of bus bars include one bus bar having one main surface opposing a side wall intersecting the fixing wall, the one bus bar extending along the side wall, the one bus bar has an end portion from which the fixing member protrudes and another portion that is a portion of the one bus bar other than the end portion, and the side wall has the second heat dissipation portion at a position opposing the end portion of the one bus bar, and a first heat dissipation portion at a position opposing the other portion of the one bus bar.

In this embodiment, heat from the end portion of the one bus bar from which the fixing member protrudes is dissipated by convection dissipation performed by the second heat dissipation portion, and heat from the other portion of the one bus bar, which is the portion other than the end portion, is dissipated by emission dissipation performed by the first heat dissipation portion. In this manner, heat from the one bus bar is dissipated by an appropriate combination of the first heat dissipation portion and the second heat dissipation portion, thus making it possible to more effectively dissipate heat from an electronic component.

(7) In the electrical junction box according to an embodiment of the present disclosure, the first heat dissipation portion is provided on a side corresponding to an other main surface of the other portion.

In this embodiment, the first heat dissipation portion is provided on both main surface sides of the other portion of the one bus bar, and heat is dissipated by emission on both main surface sides. Therefore, the effect of heat dissipation by the first heat dissipation portion can be further improved.

(8) In the electrical junction box according to an embodiment of the present disclosure, the plurality of bus bars include another bus bar having a flattened portion having an opposing surface opposing the fixing wall, the fixing wall has the first heat dissipation portion at a position opposing the opposing surface of the flattened portion, the flattened portion has an opposite surface on a side opposite to the opposing surface, a fixing member protrudes from the opposite surface, and the second heat dissipation portion is provided on a side corresponding to the opposite surface.

In this embodiment, heat from the opposing surface of the flattened portion of the other bus bar is dissipated by emission dissipation performed by the first heat dissipation portion, and heat from the opposite surface of the flattened portion is dissipated by convection dissipation performed by the second heat dissipation portion. In this manner, heat from the other bus bar is dissipated by an appropriate combination of the first heat dissipation portion and the second heat dissipation portion, thus making it possible to more effectively dissipate heat from an electronic component.

(9) In the electrical junction box according to an embodiment of the present disclosure, the first distance is smaller than the second distance.

In this embodiment, when the distance from the bus bar is the first distance or less, heat is dissipated by emission dissipation performed by the first heat dissipation portion, and when the distance from the bus bar is longer than the first distance (i.e., the second distance or more), heat is dissipated by convection dissipation performed by the second heat dissipation portion, thus making it possible to more effectively dissipate heat from an electronic component.

### Details of Embodiments of Present Disclosure

Embodiments of an electrical junction box according to the present disclosure will be described below with reference to the drawings. However, the present invention is not limited to these examples, but rather is defined by the scope of the claims, and is intended to include all modifications within the meaning and scope equivalent to the claims.

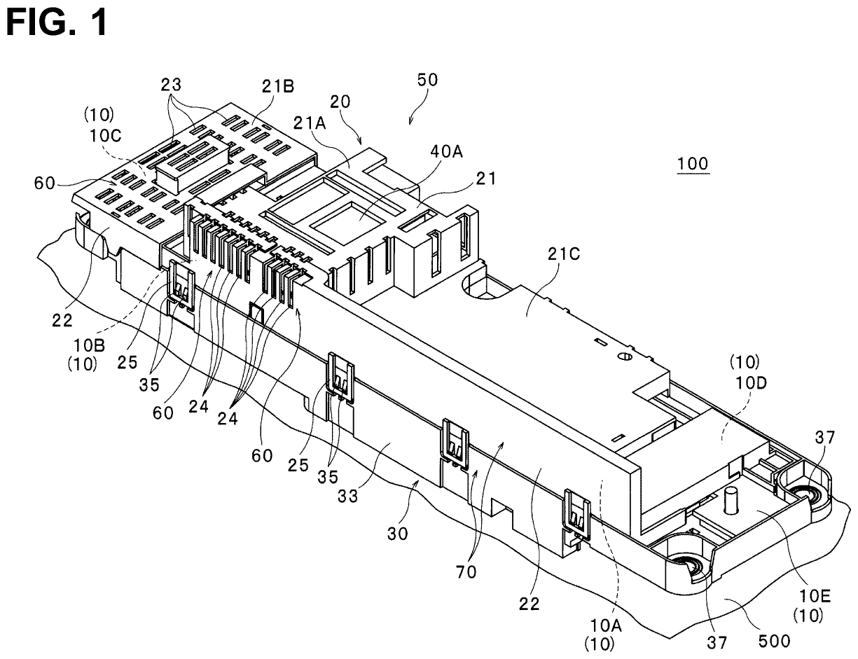

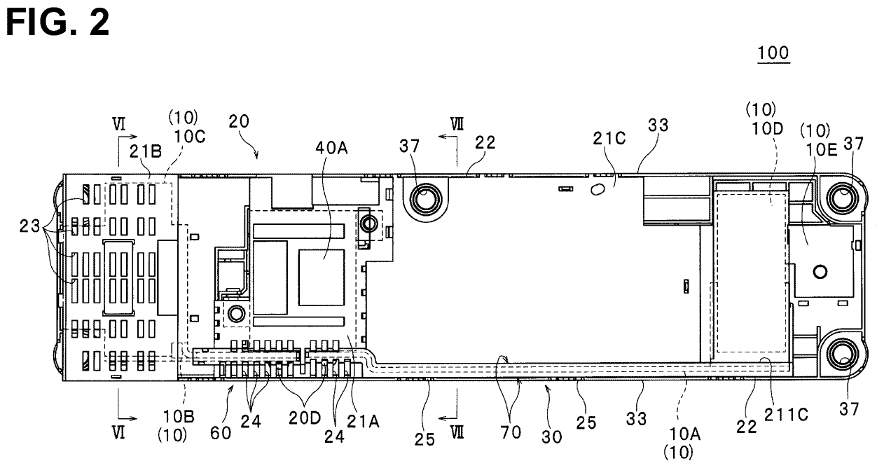

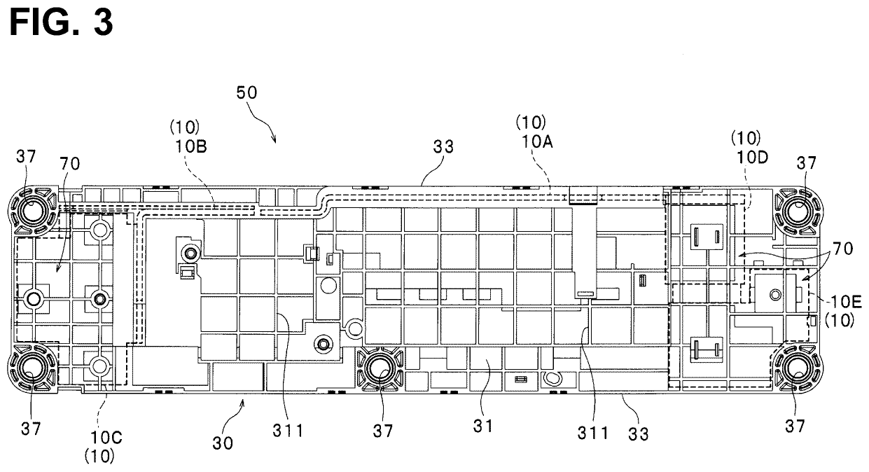

FIG. 1 is a perspective view of an electrical junction box 100 according to the present embodiment, FIG. 2 is a plan view of the electrical junction box 100 according to the present embodiment, and FIG. 3 is a bottom view of the electrical junction box 100 according to the present embodiment. In FIGS. 2 and 3, the positions of later-described bus bars 10 are indicated by dashed lines.

The electrical junction box 100 is configured to be attached to the outside of a target object such as a battery pack 500 of an electric vehicle (EV). For convenience, FIG. 1 shows a state in which the electrical junction box 100 is attached to the battery pack 500.

The electrical junction box 100 includes a housing 50 that houses, for example, at least one relay 40A, a circuit board, and the like. The housing 50 has a substantially rectangular shape in a plan view, and is made of, for example, a material (e.g., resin) having a higher emissivity than the later-described bus bars 10.

The housing 50 includes a lower case 30 that is attached to the target object, and an upper case 20 that partially covers the lower case 30. Electronic components such as the relay 40A and the bus bars 10 are attached to the lower case 30, and the upper case 20 covers some of these electronic components.

For convenience of description, the upper case 20 side will be referred to as the upper side, and the lower case 30 side will be referred to as the lower side.

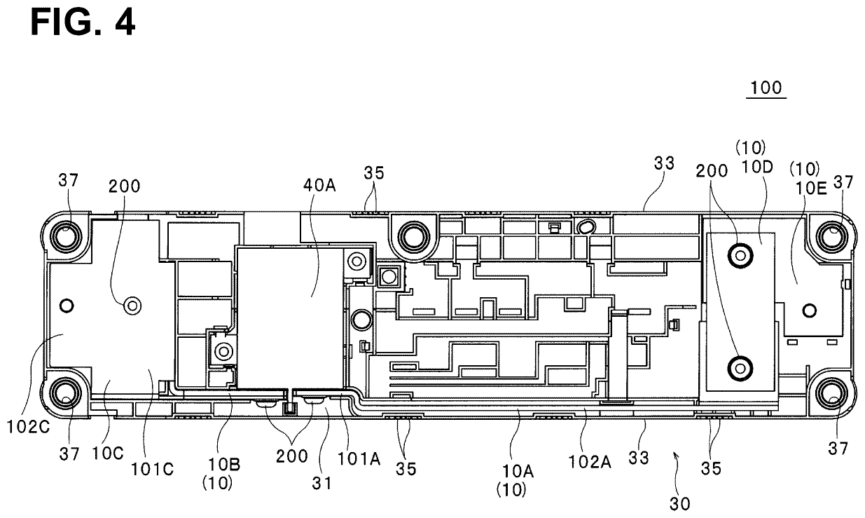

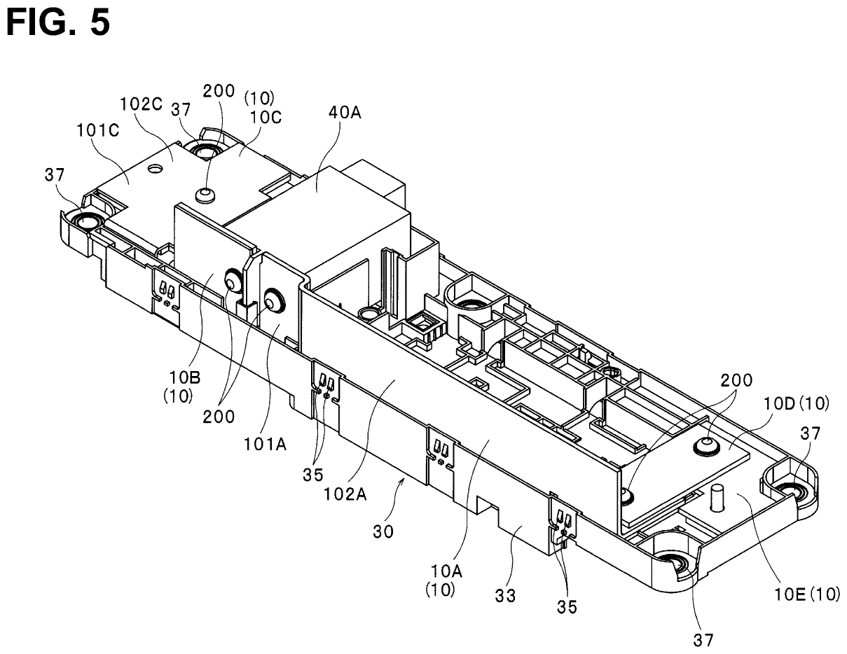

FIG. 4 is a plan view showing the electrical junction box 100 of the present embodiment with the upper case 20 removed, and FIG. 5 is a perspective view showing the electrical junction box 100 of the present embodiment with the upper case 20 removed.

The lower case 30 is shaped as a flattened box that is open on the upper case 20 side. The lower case 30 has a substantially rectangular bottom wall 31 (fixing wall) whose outer side is configured to come into contact with and be fixed to the target object, and side walls 33 that extend perpendicularly from the edges of the bottom wall 31 toward the upper case 20. The bottom wall 31 has steps formed on the two end sides, and the two end portions are positioned higher than the middle portion. Accordingly, the side walls 33 at the end portions of the bottom wall 31 have a shorter height dimension. Additionally, ribs 311 are formed in a lattice shape on the outer surface of the bottom wall 31. As described above, the relay 40A and the bus bars 10 are provided inside the lower case 30.

Among the side walls 33 of the lower case 30, the outer surfaces of the side walls 33 on the long sides of the bottom wall 31 include a plurality of engagement projections 35 that engage with later-described engagement portions 25 of the upper case 20. The engagement projections 35 are provided in pairs, each pair including two projections spaced apart from each other in the length direction of the side walls 33.

Furthermore, the bottom wall 31 is provided with fixing holes 37, which are formed at the four corners and in the vicinity of one side wall 33 and are used when attaching the lower case 30 (housing 50) to the target object. Note that a notch is formed in the one side wall 33 in the vicinity of the fixing hole 37.

As shown in FIGS. 4 and 5, for example, one relay 40A is provided in the lower case 30. The relay 40A is provided with two connection terminals (not shown) facing a side wall 33 on one long side in the width direction of the lower case 30.

A plurality of types of bus bars 10 are provided in the lower case 30. The types of bus bars 10 include a bus bar 10A (one bus bar) and a bus bar 10B connected to the connection terminals of the relay 40A, a bus bar 10C (another bus bar) provided at one end portion of the lower case 30, and a bus bar 10D and a bus bar 10E provided at the other end portion of the lower case 30. The bus bar 10A, the bus bar 10B, the bus bar 10C, the bus bar 10D, and the bus bar 10E are made of a material (e.g., copper) having a lower emissivity than the lower case 30 (housing 50).

The bus bar 10A and the bus bar 10B are disposed in the vicinity of the side wall 33 on the one long side of the lower case 30. The bus bar 10A and the bus bar 10B are each provided such that one main surface thereof opposes the one long-side side wall 33. In other words, the bus bar 10A and the bus bar 10B are provided standing perpendicularly to the bottom wall 31.

The bus bar 10A has a rectangular plate shape and extends along the one long-side side wall 33. The bus bar 10A has a step formed in the vicinity of one end portion 101A in the length direction, and has a crank shape in a plan view. The bus bar 10A is disposed such that another portion 102A, which is the portion other than the one end portion 101A, is closer to the one long-side side wall 33 than the one end portion 101A is. Out of the two connection terminals of the relay 40A, the one end portion 101A of the bus bar 10A is screwed to the connection terminal (other component) closer to the other end of the lower case 30 using a screw 200 (fixing member). The screw 200 protrudes from the one surface of the bus bar 10A (one end portion 101A) that opposes the one long-side side wall 33.

The bus bar 10B has a rectangular plate shape and extends along the one long-side side wall 33. Out of the two connection terminals of the relay 40A, one end portion of the bus bar 10B is screwed to the connection terminal closer to the one end portion of the lower case 30 using a screw 200.

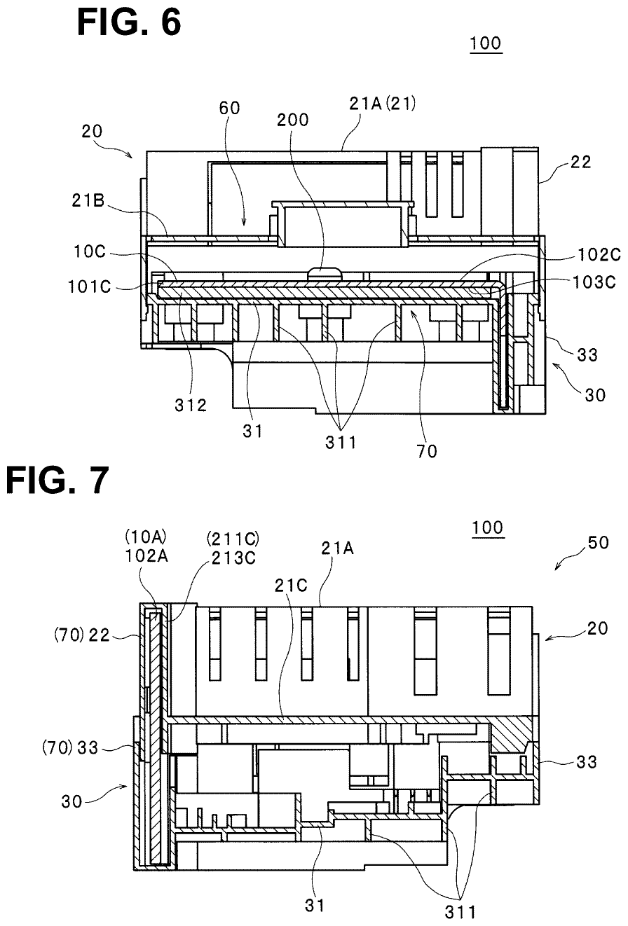

FIG. 6 is a vertical cross-sectional view taken along a line VI-VI in FIG. 2. FIG. 6 shows the configuration of the one end portion of the lower case 30.

The bus bar 10C is provided at the one end portion of the lower case 30. The bus bar 10C is made of a plate member and has a flattened portion 101C disposed opposing the bottom wall 31, and one edge portion of the flattened portion 101C is bent toward the bottom wall 31. In other words, the flattened portion 101C has an opposing surface 103C that opposes the bottom wall 31. Portions of the flattened portion 101C corresponding to two fixing holes 37 in the up-down direction are cut out.

The bus bar 10C is fixed to the bottom wall 31 by a screw 200 with an intervening member 312 disposed therebetween. In this case, the distance from the opposing surface 103C to the bottom wall 31 is 1 mm or less. Furthermore, in the central portion of the flattened portion 101C, the screw 200 protrudes from an opposite surface 102C on the side opposite to the opposing surface 103C. The opposite surface 102C opposes a later-described ceiling wall 21B (see FIGS. 1 and 2) of the upper case 20.

The bus bar 10D and the bus bar 10E are provided at the other end portion of the lower case 30. The bus bar 10D has a rectangular plate shape, the bus bar 10E is plate-shaped, and the bus bar 10D and the bus bar 10E are disposed opposing the bottom wall 31. The bus bar 10D and the bus bar 10E partially overlap each other in the up-down direction, and the bus bar 10E is provided below the bus bar 10D, that is, on the bottom wall 31 side. A portion of the bus bar 10E corresponding to one fixing hole 37 in the up-down direction is cut out.

The bus bar 10D and the bus bar 10E are screwed to the bottom wall 31 using screws 200, and the screws 200 protrude from the upper surface of the bus bar 10D. At this time, the distance from the lower surfaces of the bus bar 10D and the bus bar 10E to the bottom wall 31 is 1 mm or less. The bus bar 10D has an upper surface that is exposed to the outside air, and the bus bar 10E has an upper surface that is partially exposed (see FIGS. 1 and 2).

The upper case 20 is shaped as a box that is open on the side facing the lower case 30. The upper case 20 partially covers the lower case 30, and as described above, the bus bar 10D, the bus bar 10E, and the like at the other end portion of the lower case 30 are exposed to the outside (see FIGS. 1 and 2).

The upper case 20 has a ceiling wall 21 opposing the bottom wall 31, and side walls 22 extending perpendicularly from the edges of the ceiling wall 21 toward the lower case 30. A step is formed in the ceiling wall 21. Specifically, steps are formed in the ceiling wall 21 at one end side portion (hereinafter referred to as a ceiling wall 21B) and another end side portion (hereinafter referred to as a ceiling wall 21C) in the length direction of the lower case 30, which are on respective sides of the portion corresponding to the relay 40A, that is to say the portion covering the relay 40A (hereinafter referred to as a ceiling wall 21A). Therefore, the ceiling wall 21B and the ceiling wall 21C are lower than the ceiling wall 21A.

The side walls 22 extend in the length direction of the lower case 30, and since the ceiling wall 21A and the ceiling wall 21B are located at different positions in the up-down direction as described above, the height dimension of the side walls 22 varies from place to place. Furthermore, the width of the upper case 20 is slightly smaller than the width of the lower case 30, and the side walls 22 oppose the side walls 33 of the lower case 30 and abut against the inner surfaces of the side walls 33 (see FIG. 7). At this time, the side walls 22 are interposed between the side walls 33 of the lower case 30 and the bus bars 10A and 10B.

A plurality of through holes are formed in the ceiling wall 21A, and the relay 40A is partially exposed through the through holes. Also, a plurality of side-wall through holes 24 are formed in the side wall 22 pertaining to the ceiling wall 21A. The side-wall through holes 24 are formed at predetermined intervals in the length direction of the lower case 30. The side-wall through holes 24 are elongated in the up-down direction and extend from the upper end portion of the side wall 22 to the edge portion of the ceiling wall 21A. Note that the side-wall through holes 24 have a width of, for example, several mm, which is small enough to prevent the insertion of the fingertips of a person handling the case.

More specifically, the side-wall through holes 24 are formed at positions opposing the connection portions where the relay 40A is connected to the bus bar 10B and the bus bar 10A. In other words, the screws 200 for fixing the bus bar 10B and the bus bar 10A to the connection terminals of the relay 40A protrude from the bus bar 10B and the bus bar 10A at positions opposing the side-wall through holes 24 (see FIG. 4). At this time, the distance from the connection portions of the bus bar 10B and the bus bar 10A to the side wall 22 is 5 mm.

A plurality of ceiling-wall through holes 23 are formed in the ceiling wall 21B, and the bus bar 10C is partially exposed through the ceiling-wall through holes 23. More specifically, a plurality of rows of ceiling-wall through holes 23 extending in the length direction of the lower case 30 are formed at intervals in the width direction of the lower case 30. Note that a central portion of the ceiling wall 21B protrudes upward (see FIGS. 1 and 2). Also, the ceiling-wall through holes 23 have a width of, for example, several mm, which is small enough to prevent the insertion of the fingertips of a person handling the case.

The ceiling wall 21B opposes the flattened portion 101C of the bus bar 10C. As described above, the screw 200 for fixing the bus bar 10C to the bottom wall 31 protrudes from the opposite surface 102C of the flattened portion 101C, and the ceiling-wall through holes 23 of the ceiling wall 21B oppose the screw 200. Here, the distance from the opposite surface 102C of the bus bar 10C to the ceiling wall 21B is 5 mm.

The ceiling wall 21C has a flattened portion and a protruding portion 211C that is provided in the vicinity of one side wall 22 and rises perpendicularly.

FIG. 7 is a vertical cross-sectional view taken along a line VII-VII in FIG. 2.

The protruding portion 211C is disposed in the vicinity of one side wall 22, in other words, in the vicinity of the bus bar 10A. The protruding portion 211C has a cover portion 213C that covers the other main surface of the other portion 102A of the bus bar 10A.

The flattened portion of the ceiling wall 21C is connected to the surface of the cover portion 213C on the side opposite to the other main surface of the other portion 102A.

The cover portion 213C has a substantially rectangular shape extending in the length direction of the lower case 30, and has an inverted L-shape in vertical cross section. In other words, the majority of the cover portion 213C is a flat plate portion that opposes the other main surface of the bus bar 10A (other portion 102A), and the upper edge portion of the flat plate portion is bent toward the bus bar 10A. The one side wall 22 is connected to the upper edge of the cover portion 213C. The upper end of the cover portion 213C is at the same position as the upper surface of the ceiling wall 21A in the up-down direction. Hereinafter, for convenience, the flat plate portion of the cover portion 213C will also be referred to as the cover portion 213C.

The cover portion 213C opposes the bus bar 10A (other portion 102A) and the one side wall 22 with a predetermined gap therebetween. The bus bar 10A (other portion 102A) is interposed between the cover portion 213C and the side wall 22. In other words, the side wall 22 opposes the one main surface of the bus bar 10A (other portion 102A), and the cover portion 213C opposes the other main surface of the bus bar 10A (other portion 102A).

As shown in FIG. 7, the outer surface of the lower end portion of the side wall 22 is in contact with the inner surface of the side wall 33 of the lower case 30. As described above, the side wall 33 of the lower case 30 also opposes the one main surface of the bus bar 10A (other portion 102A).

The distance from the side wall 22 to the bus bar 10A, the distance from the cover portion 213C to the bus bar 10A, and the distance from the side wall 33 of the lower case 30 to the bus bar 10A are all 1 mm or less.

Additionally, a plurality of engagement portions 25 for engaging with the engagement projections 35 of the lower case 30 are provided at locations on the lower end portions of the side walls 22 of the upper case 20. Each of the engagement portions 25 is U-shaped, with two end portions on the open side that are fixed to the side wall 22, and a curved portion that protrudes downward from the side wall 22. When assembling the upper case 20 and the lower case 30, the engagement projections 35 of the lower case 30 pass between the edges of the side walls 22 and the curved portions of the engagement portions 25 on the inward side of the engagement portions 25, and thus the engagement projections 35 engage with the engagement portions 25 (see FIG. 1).

In the electrical junction box 100, during energization, heat is generated by the relay 40A and the like, and the heat from the relay 40A is immediately transferred to the bus bar 10 that is in direct contact. The heat generated by the relay 40A may adversely affect the electronic components around the relay 40A and the bus bar 10, and therefore it is necessary to cool the relay 40A and the bus bar 10 quickly. However, the extent of heat dissipation due to the dissipation of heat from the relay 40A itself cannot be expected to be large, and heat dissipation via the bus bars 10 connected to the relay 40A is more efficient.

The electrical junction box 100 of the present embodiment includes a first heat dissipation portion 70 and a second heat dissipation portion 60, which have different heat dissipation mechanisms, and by appropriately combining the heat dissipation mechanism pertaining to the first heat dissipation portion 70 and the heat dissipation mechanism pertaining to the second heat dissipation portion 60, heat generated by the relay 40A is efficiently dissipated via the bus bars 10.

The first heat dissipation portion 70 and the second heat dissipation portion 60 are disposed in the vicinity of the bus bars 10. The first heat dissipation portion 70 is spaced apart from the bus bars 10 by a first distance or less and dissipates heat by emission, and the second heat dissipation portion 60 is spaced apart from the bus bars 10 by a second distance or more and dissipates heat by convection. Here, the first distance is smaller than the second distance. For example, the first distance is 1 mm and the second distance is 5 mm.

In the electrical junction box 100 of the present embodiment, heat from the bus bar 10A is dissipated by emission dissipation performed by the first heat dissipation portion 70 (hereinafter simply referred to as emission dissipation) and by convection dissipation performed by the second heat dissipation portion 60 (hereinafter simply referred to as convection dissipation). Specifically, heat from the one end portion 101A of the bus bar 10A is dissipated by convection dissipation performed by the second heat dissipation portion 60, and heat from the other portion 102A is dissipated by emission and convection performed by the first heat dissipation portion 70.

In the one side wall 22 of the upper case 20, the portion opposing the one end portion 101A of the bus bar 10A corresponds to the second heat dissipation portion 60. As described above, the portion corresponding to the second heat dissipation portion 60 opposes the connection portion between the bus bar 10A and the relay 40A, and since the screw 200 protrudes from the connection portion, the portion corresponding to the second heat dissipation portion 60 and the one end portion 101A of the bus bar 10A are spaced apart from each other by approximately 5 mm, which is wider than the first distance. Also, the portion corresponding to the second heat dissipation portion 60 has a plurality of side-wall through holes 24.

Therefore, outside air can flow into the housing 50 and out from the housing 50 through the side-wall through holes 24, and since the portion corresponding to the second heat dissipation portion 60 and the one end portion 101A of the bus bar 10A are spaced apart from each other by approximately 5 mm, incoming outside air can easily flow. Therefore, convection occurs due to the flow of outside air, and heat generated by the connection portion of the bus bar 10A due to connection resistance is dissipated. It is also possible to prevent the fingertips of a person handling the case from touching the bus bar 10A.

Also, the cover portion 213C and the portion of the one side wall 22 of the upper case 20 that opposes the other portion 102A of the bus bar 10A correspond to the first heat dissipation portion 70. For convenience, hereinafter, the cover portion 213C and the portion of the side wall 22 of the upper case 20 that opposes the other portion 102A of the bus bar 10A will be referred to as the portion corresponding to the first heat dissipation portion 70.

As described above, the inner surface of the portion corresponding to the first heat dissipation portion 70 opposes the other portion 102A of the bus bar 10A, and the outer surface is exposed to the outside air. Also, the portion corresponding to the first heat dissipation portion 70 and the other portion 102A of the bus bar 10A are spaced apart from each other by approximately 1 mm.

In this way, although the flow of air is poor due to the narrow gap between the portion corresponding to the first heat dissipation portion 70 and other portion 102A of the bus bar 10A, heat emission (i.e., heat radiation) is likely to occur, and heat dissipation by emission is effective and takes precedence. Therefore, heat generated in the other portion 102A of the bus bar 10A is transferred by emission to the portion corresponding to the first heat dissipation portion 70, and is dissipated via the outer surface of the portion corresponding to the first heat dissipation portion 70.

Also, in the electrical junction box 100 of the present embodiment, heat from the bus bar 10B is dissipated by convection dissipation performed by the second heat dissipation portion 60.

The portion of the side wall 22 of the upper case 20 that opposes the connection portion between the bus bar 10B and the relay 40A corresponds to the second heat dissipation portion 60. In the following description, for convenience, the portion of the side wall 22 of the upper case 20 that opposes the connection portion between the bus bar 10B and the relay 40A will be referred to as the portion corresponding to the second heat dissipation portion 60.

As described above, the portion corresponding to the second heat dissipation portion 60 opposes the connection portion of the bus bar 10B, and since the screw 200 protrudes from the connection portion, the portion corresponding to the second heat dissipation portion 60 and the bus bar 10B are spaced apart from each other by approximately 5 mm. Also, the portion corresponding to the second heat dissipation portion 60 has a plurality of side-wall through holes 24.

Therefore, outside air can flow into the housing 50 and out from the housing 50 through the side-wall through holes 24, incoming outside air can easily flow, convection can easily occur due to the flow of outside air, and heat generated by the connection portion of the bus bar 10B due to connection resistance is dissipated. It is also possible to prevent the fingertips of a person handling the case from touching the bus bar 10B.

Furthermore, in the electrical junction box 100 of the present embodiment, heat from the bus bar 10C is dissipated by emission dissipation performed by the first heat dissipation portion 70 and by convection dissipation performed by the second heat dissipation portion 60. Specifically, heat from the opposite surface 102C of the bus bar 10C is dissipated by convection dissipation performed by the second heat dissipation portion 60, and heat from the opposing surface 103C is dissipated by emission and convection performed by the first heat dissipation portion 70.

The ceiling wall 21B corresponds to the second heat dissipation portion 60. As described above, the second heat dissipation portion 60 (ceiling wall 21B) opposes the opposite surface 102C of the bus bar 10C, and since the screw 200 protrudes from the opposite surface 102C, the second heat dissipation portion 6 and the opposite surface 102C of the bus bar 10C are spaced apart from each other by approximately 5 mm. Also, the second heat dissipation portion 60 has a plurality of ceiling-wall through holes 23.

Therefore, outside air can flow into the housing 50 and out from the housing 50 through the ceiling-wall through holes 23, incoming outside air can easily flow, and heat generated by the bus bar 10C is dissipated by convection, as described above. It is also possible to prevent the fingertips of a person handling the case from touching the bus bar 10C.

Furthermore, the portion of the bottom wall 31 that opposes the opposing surface 103C of the bus bar 10C corresponds to the first heat dissipation portion 70. Hereinafter, for convenience, the portion of the bottom wall 31 that opposes the opposing surface 103C of the bus bar 10C will be referred to as the portion corresponding to the first heat dissipation portion 70.

As described above, the inner surface of the portion corresponding to the first heat dissipation portion 70 opposes the opposing surface 103C of the bus bar 10C, and the outer surface is exposed to the outside air. Also, the portion corresponding to the first heat dissipation portion 70 and the bus bar 10C are spaced apart from each other by approximately 1 mm.

In this manner, the gap between the portion corresponding to the first heat dissipation portion 70 and the bus bar 10C is narrow, and therefore emission can easily occur, and heat dissipation by emission takes precedence. Therefore, heat generated by the bus bar 10C is transferred by emission from the opposing surface 103C to the portion corresponding to the first heat dissipation portion 70, and is dissipated via the outer surface of the portion corresponding to the first heat dissipation portion 70.

In the electrical junction box 100 of the present embodiment, heat from the bus bars 10D and 10E is dissipated by emission dissipation performed the first heat dissipation portion 70. Specifically, heat from the lower surfaces of the bus bars 10D and 10E is dissipated by emission and convection performed by the first heat dissipation portion 70.

The portion of the bottom wall 31 that opposes the lower surfaces of the bus bars 10D and 10E corresponds to the first heat dissipation portion 70. Hereinafter, for convenience, the portion of the bottom wall 31 that opposes the lower surfaces of the bus bars 10D and 10E will be referred to as the portion corresponding to the first heat dissipation portion 70.

As described above, the inner surface of the portion corresponding to the first heat dissipation portion 70 opposes the lower surfaces of the bus bars 10D and 10E, and the outer surface is exposed to the outside air. Also, the portion corresponding to the first heat dissipation portion 70 is spaced apart from the bus bars 10D and 10E by approximately 1 mm.

In this manner, since the distance between the portion corresponding to the first heat dissipation portion 70 and the bus bars 10D and 10E is narrow, heat dissipation by heat emission takes precedence. Therefore, heat generated by the bus bars 10D and 10E is transferred by emission from the lower surfaces to the portion corresponding to the first heat dissipation portion 70, and is dissipated via the outer surface of the portion corresponding to the first heat dissipation portion 70.

As described above, in the electrical junction box 100 of the present embodiment, emission performed by the first heat dissipation portion 70 and convection performed by the second heat dissipation portion 60 can be appropriately combined to increase the heat dissipation efficiency of the dissipation of heat from the relay 40A and the bus bars 10.

The electrical junction box 100 of the present embodiment is not limited to the above description, and the housing 50 may be configured to include an insulating filler (e.g., ceramic oxide). In this case, thermal conduction can be increased while ensuring the insulation property of the housing 50, and the heat dissipation effect of the first heat dissipation portion 70 and the second heat dissipation portion 60 can be improved.

The embodiments disclosed herein should be considered in all respects as illustrative and not restrictive. The scope of the present invention is defined by the claims, not by the above meaning, and is intended to include all modifications within the meaning and scope equivalent to the claims.

The matter described in the respective embodiments can be combined with each other. Furthermore, the independent and dependent claims set forth in the claims can be combined with each other in any and all combinations, regardless of the form of reference. Furthermore, the claims are in a format in which a claim references two or more other claims (multiple dependent claim format), but are not limited to this format. It is also possible to use a format for describing multiple dependent claims (multi-multi claims) that cite at least one multiple dependent claim.

### List of Reference Numerals

10, 10A, 10B, 10C, 10D, 10E Bus bar

20 Upper case

21, 21A, 21B, 21C Ceiling wall

22 Side wall

23 Ceiling-wall through hole

24 Side-wall through hole

25 Engagement portion

30 Lower case

31 Bottom wall

33 Side wall

35 Engagement projection

37 Fixing hole

40A Relay

50 Housing

60 Second heat dissipation portion

70 First heat dissipation portion

100 Electrical junction box

101A One end portion

101C Flattened portion

102A Other portion

102C Opposite surface

103C Opposing surface

200 Screw

211C Protruding portion

213C Cover portion

311 Rib

312 Intervening member

500 Battery pack

1. An electrical junction box including a housing in which a plurality of bus bars are housed, heat from the bus bars being dissipated externally via the housing, the electrical junction box comprising:
a first heat dissipation portion spaced apart from the bus bars by a first distance or less and configured to dissipate heat by emission; and
a second heat dissipation portion spaced apart from the bus bars by a second distance or more and configured to dissipate heat by convection.

2. The electrical junction box according to claim 1,
wherein an emissivity of the housing is higher than an emissivity of the bus bars.

3. The electrical junction box according to claim 1,
wherein the first heat dissipation portion has one surface opposing the bus bars.

4. The electrical junction box according to claim 1,
wherein the second heat dissipation portion has a through hole.

5. The electrical junction box according to claim 4,
wherein a fixing member fixing a bus bar among the plurality of bus bars to another component protrudes at a position corresponding to the through hole.

6. The electrical junction box according to claim 5, further comprising:
a fixing wall configured to be fixed to a target object,
wherein the plurality of bus bars include one bus bar having one main surface opposing a side wall intersecting the fixing wall, the one bus bar extending along the side wall,
the one bus bar has an end portion from which the fixing member protrudes and another portion that is a portion of the one bus bar other than the end portion, and
the side wall has the second heat dissipation portion at a position opposing the end portion of the one bus bar, and the first heat dissipation portion at a position opposing the other portion of the one bus bar.

7. The electrical junction box according to claim 6,
wherein the first heat dissipation portion is provided on a side corresponding to an other main surface of the other portion.

8. The electrical junction box according to claim 6,
wherein the plurality of bus bars include another bus bar having a flattened portion having an opposing surface opposing the fixing wall,
the fixing wall has the first heat dissipation portion at a position opposing the opposing surface of the flattened portion,
the flattened portion has an opposite surface on a side opposite to the opposing surface,
a fixing member protrudes from the opposite surface, and
the second heat dissipation portion is provided on a side corresponding to the opposite surface.

9. The electrical junction box according to claim 1,
wherein the first distance is smaller than the second distance.
